(19) United States
(12) Patent Application Publication
(10) Pub. No.: US 2022/0042360 A1
(43) Pub. Date: Feb. 10, 2022

(54) CHILD LOCK FOR A SLIDING WINDOW OR DOOR

(71) Applicant: Jesper Birk Andersen, Hong Kong (CN)

(72) Inventor: Jesper Birk Andersen, Hong Kong (CN)

(21) Appl. No.: 17/361,876

(22) Filed: Jun. 29, 2021

(30) Foreign Application Priority Data
Aug. 7, 2020 (GB) 2012336.0

(51) Int. Cl. E05C 19/02

(52) U.S. Cl. CPC E05C 19/02

(57) ABSTRACT

The invention relates to a child lock 10 for a sliding window or door 7, 37 arranged in a frame or support 6, 36, comprising a base part 11, 21 and a wing part 13, 22 pivotally arranged on a side of the base part 11, 21; the base part 11, 21 including a means of attachment to the existing frame or support 6, 36 by adhesive or screws or like, and a spring 14, 24 is provided acting on the wing part 22 and which urges the wing part 22 into a first position out of alignment with the base part 11,21 and in which first position it impedes the movement of a window or door when the lock is fitted by a user into a location adjacent to the edge of the window or door which is desired to be locked, and which wing part 13, 22 is movable by the user in a first direction against the action of the spring 14, 24 to a second position in which is does not impede the movement of the window or door 7, 37 and the door or window 7, 37 may then be opened and whilst open retains the wing part 13, 22 in the second position, wherein a secondary lock wing part 15, 27 is provided and arranged on the wing part 13, 22 the secondary lock wing part 15, 27 being urged by means of a secondary lock spring 16, 28 which urges the secondary lock wing part into a locked position which acts to prevent movement of the wing part 13, 22 the secondary lock wing part 15, 27 being movable by the user in a second direction to an unlocked position in which movement of the winged part 13, 22 is permitted enabling the wing part 13, 22 to be pressed to the second position in which the movement of the window or door, 6,7, 37 is not impeded. The secondary lock wing part 15, 27 can be pivotally arranged on the wing part 13, 22. The second direction is approximately orthogonal to the first direction.

The present invention relates to a child lock for a sliding window or door, the window or door being arranged to slide in a frame and the child lock being arranged to prevent sliding of the window or door. The child lock being actuatable to permit sliding of the window or door in a way that is difficult to be actuated by small children.

### BACKGROUND THE INVENTION

Sliding windows and doors are commonly used in daily life in kitchens, bedrooms, offices, etc. as well as on cupboards to store a wide range of articles, some of which may be harmful to children. Small children may attempt to climb out of windows or through doors, or even in, drawers and cabinets in an effort to hide. Drawers and cabinets may house many types of materials which may be potentially hazardous to children such as medicines, household cleaners, knives, tools, paint, etc.

To prevent young children from opening doors and windows and falling from a height or accessing these dangerous spaces or storage areas, numerous items have been patented and sold, most of a multi-piece assembly. Generally, some sort of a lock member is attached to the inside surface of the frame of the window or door to prevent the window or door from sliding and therefore from being opened.

In many cases, locks are part of the handle and may require the use of a key which an adult can store in a secret or inaccessible place.

Alternatively or additionally stop means are provided on a horizontal part of the frame which have wing parts which are configured to extend under the action of a spring in the path of the window or door to block movement of the window or door and may be pressed against the action of the spring to be moved to a position in which the window or door may be moved.

These child safety stop means require a minimum spring force of 50 Newtons in order to effectively prevent children from successfully pressing in the wing parts and successfully allowing the door or window to slide open. Such a force of 50 Newtons is also too large for some adults, in particular the elderly, or those suffering from arthritis or similar disability to be able to operate the stop to release the window or door when needed.

In additional the 50 Newton spring force continues to act on the inside surface of the door or window during the sliding back and forth of the door or window once the wing parts have been depressed to release the lock, which has a tendency to damage the inside surface of the door or window by the action of repeated rubbing.

It is thus an Object of the present invention to provide an improved child lock for a sliding door or window which alleviates these disadvantages.

The invention herein is defined in the appended claims.

There now follows a detailed description of an embodiment of the invention with reference to the attached drawings which are as follows:

### DESCRIPTION OF THE DRAWINGS

FIG. 1: shows a perspective view of a child lock for a sliding door or window as known in the prior art,

FIG. 2 shows a top view of a child lock for windows or doors according to a first embodiment of the invention in a locked position,

FIG. 3 shows a side view of the embodiment of FIG. 2 in the locked position,

FIG. 4 shows a perspective view of the embodiment of FIG. 2 showing the movement to an unlocked position,

FIG. 5 shows a perspective view of the child lock of FIG. 2 in the locked position,

FIG. 6 shows the same view as FIG. 5 and also shows the directions of movement required to release the lock,

FIG. 7 shows the lock of FIG. 5 in the released position,

FIG. 8 shows the lock of FIG. 5 with the door or window partially open,

FIG. 9 shows a plan view of a child lock for a sliding window or door according to a further embodiment of the invention,

FIG. 10 shows a perspective view of the child lock of FIG. 9,

FIG. 11 shows a perspective view of the child lock of FIG. 9,

FIG. 12 shows a side view of the child lock of FIG. 9 in the open position, and

FIG. 13 shows a perspective view of the child lock of FIG. 9 in the open position.

### DETAILED DESCRIPTION

The present invention is described more fully hereinafter with reference to the accompanying drawings, in which preferred embodiments of the invention are shown. This invention, may, however, be embodied in many different forms and should not be construed as limited to the embodiments set forth herein; rather, these embodiments are provided so that this disclosure will be thorough and complete, and will fully convey the scope of the invention to those skilled in the art.

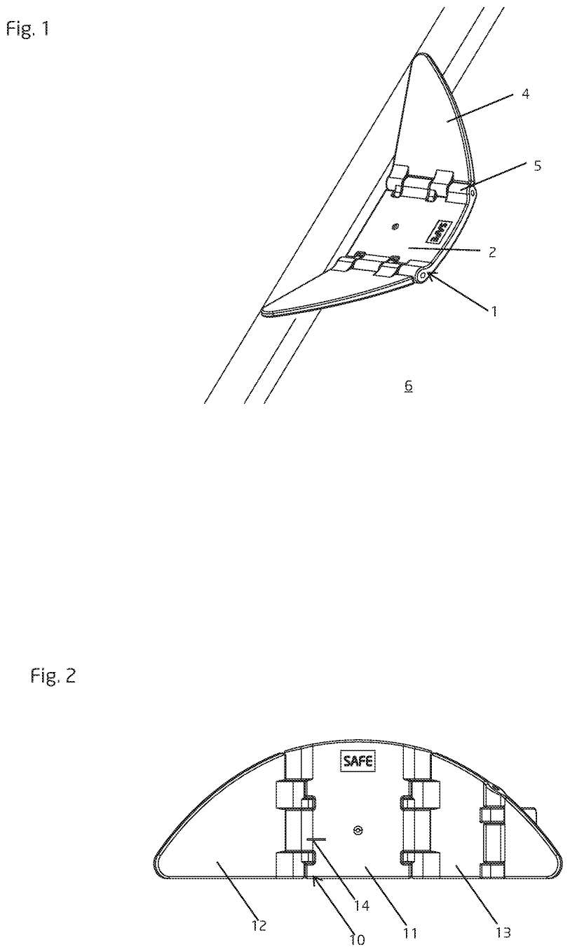

Referring now to FIG. 1 a child lock 1 for sliding doors or windows is shown that is known in the prior art, this known child lock 1 comprises a base part 2 centrally arranged which is fixed to a frame 3 of the door or window by known means such as adhesive or by screws. On each side of the base part 2 is provided a wing part 4 which is rotatably movable with respect to the base part 2 and out of the plane of the base part 2 about a hinge 5. The wing part 4 is biased by means of a spring to extend out of the plane of the base part 2 and to impede the movement of the door or window which is intended to be closed and the opening of which by a child is to be prevented. Thus when an adult wishes to open the door or window the wings 4 need to be depressed inwards against the action of the spring such that they are approximately in the plane of the base part 2 and no longer impede the door or window. The door or window can then be slid open and the wing parts 4 are retained in the plane of the base part 2 by the inside surface of the door or window whilst the door or window is open. When the door or window is closed again the wing parts 4 automatically return to the position in which they extend out of the plane of the base part 2 and once again impede the movement of the door or window automatically due to the action of the spring.

Reference is now made to FIGS. 2-8 which shows a first embodiment of the child lock for a sliding window or door 7 according to the invention. The child lock 10 includes a base part 11 and wing parts 12, 13 arranged on each side of the base part 11. The base part 11 includes a means of attachment to an existing frame or support 6 which maybe by means of adhesive or screws or like. A spring 14 is provided which urges each wing part 12, 13 into a position out of alignment with the base part 11 and in which position they serve to impede the movement of the window or door 7 when the lock is fitted by a user into a position adjacent to the edge of the window or door 7 which is desired to be locked.

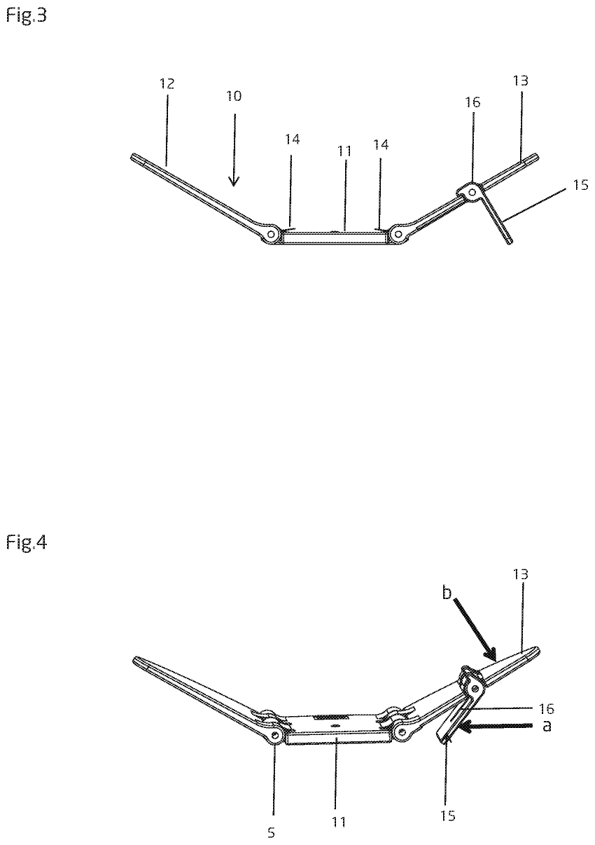

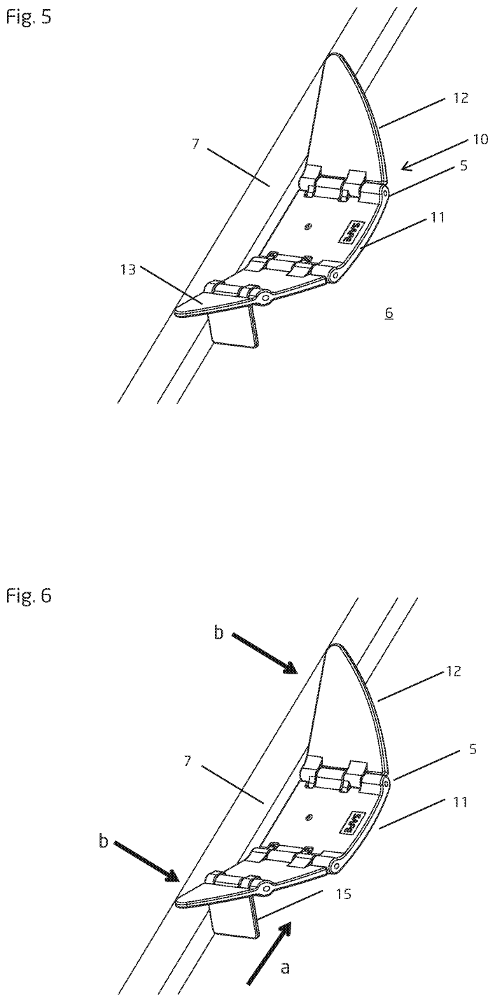

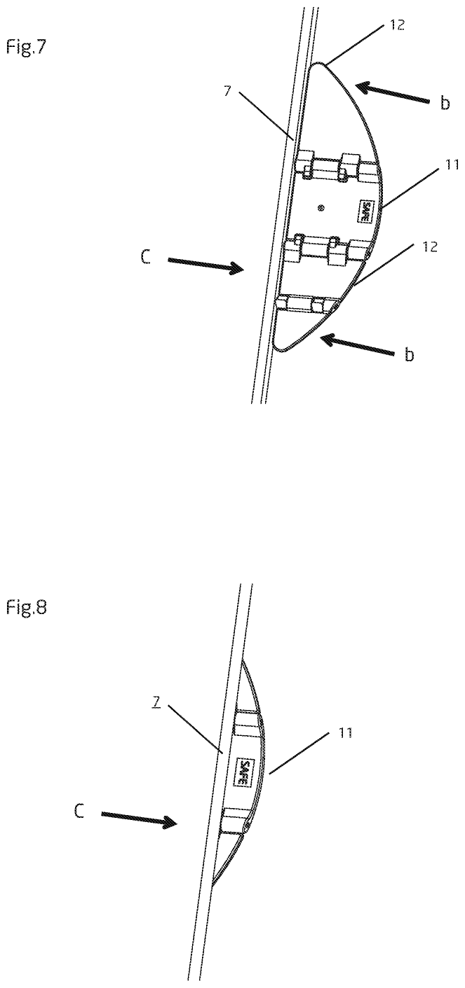

In this embodiment a secondary lock wing part 15 is provided and arranged on the wing part 13 as best shown in FIGS. 3 to 6. This secondary lock wing part 15 is similarly urged by means of a spring 16 which urges the secondary lock wing part 15 into a position which is approximately orthogonal to the plane of the wing part 13 and extending towards the plane of the base part 11 such that the secondary lock wing part 15 acts to prevent downward movement of the wing part 13 by acting as a brace or stay against the surface of the frame or support 6 to which the base part 11 is attached. Thus in order to move the wing part 13 from a locked to an unlocked position permitting sliding of the door or window 7 it is necessary to first pivot the secondary lock wing part 15 out of the orthogonal position against the spring 16 to a position adjacent to the wing part 13, in the direction of arrow “a” in FIG. 6, enabling the wing part 13 to be pressed downwards (as shown in FIG. 3) and out of engagement with the door or window. Once the secondary lock wing part 15 is released the wing part 13 may then be pressed towards the frame or support 6 in the direction of arrow “b” as shown in FIGS. 6 and 7 along with the other wing part 12, until they are aligned with the base part 11. This may conveniently be done by the user using the thumb and forefinger of a single hand. The window or door 7 is then free to be moved and may be moved in the direction of arrow “c,” as shown in FIG. 8. The door or window may then be opened and the wing parts 12, 13 act against the inside surface of the door or window at all times that the door window is open and automatically return to the blocking position when the door or window is closed and similarly the secondary lock wing part 15 automatically returns to the approximately orthogonal position in which it braces the wing part 13 against any downward movement.

This secondary required action of rotation of the secondary lock wing part 15 as well as the downward movement of the wing part 13 is significantly more difficult for a small child to achieve. As a result the child lock is more effective against being opened by a child and to such an extent that it still serves effectively as a child lock with a spring force provided by spring 14 as well as spring 16 being each significantly lower than 50 Newtons. With this embodiment the child lock is effective with a spring force on each spring 14 and 16 of about 20 Newtons. This enables the lock to be operated by adults that who have limited strength but nevertheless the required dexterity and acumen of an adult, not possessed by a child, to be able to carry out the double movement. In addition, as a result of the lower spring force the force acting on the inside surface of the door or window whilst the door or window is open or being opened or being closed is significantly less which results in a lower risk of, or degree of, damage due to scratching or rubbing on the inside surface of the window or door.

Reference is now made to FIG. 4 in which an orthogonal view of the lock of the invention in this first embodiment is shown during the operation by an adult user moving the lock from the locked position to the unlocked position. In this particular stage shown, the secondary lock wing part 15 has already been rotated to be approximately adjacent with the wing part 13 enabling the wing part 13 to be pushed into the unlocked position in the plane of the base part 11.

A secondary lock wing part may additionally be provided on the second wing part 12.

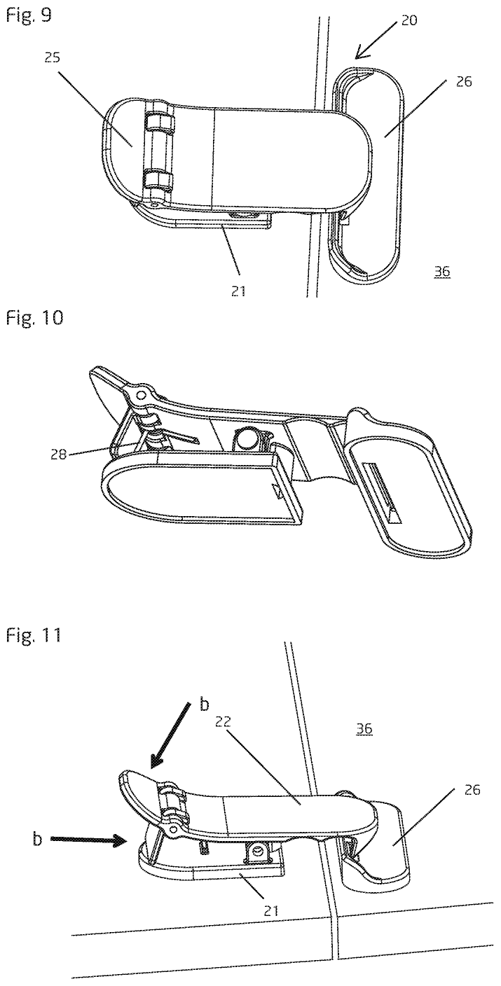

Reference is now made to FIGS. 9-12 which shows a further embodiment of the invention being a child lock 20 for a sliding window or door 36. The child lock 20 includes a base part 21 and wing parts 22, 25 arranged on each side of the base part 21. The base part 21 includes a means of attachment to an existing frame or support 37, which could also be another sliding door or window, which maybe by means of adhesive or screws or like. The child lock of this embodiment also includes a catching plate 26 fixed to a surface of the sliding door or window 36. A spring 24 is provided which urges the wing part 22 into a position in which a hooked part 29 of the wing part 22 engages with a corresponding recess 30 of the catching plate 26 and in which position they serve to impede the movement of the window or door 36, 37 when the catching plate 26 and base part 21 of the lock 20 are fitted by a user into positions adjacent to the edges of the corresponding window or door 36, 37 which are desired to be locked.

In this embodiment a secondary lock wing part 27 is provided and arranged on the wing part 22 as best shown in FIGS. 10, 11. This secondary lock wing part 27 is similarly urged by means of a spring 28 which urges the secondary lock wing part 27 into a position which is approximately orthogonal to the plane of the wing part 22 and extending towards the plane of the base part 21 such that the secondary lock wing part 22 acts to prevent downward movement of the wing part 22 by acting as a brace or stay against the surface of the frame or support 37 to which the base part 21 is attached. Thus in order to move the wing part 22 from a locked to an unlocked position permitting sliding of the door or window 36, 37 it is necessary to first pivot the secondary lock wing part 27 out of the orthogonal position against the spring 28 to a position adjacent to the wing part 22, in the direction of arrow “1” in FIG. 10, enabling the wing part 22 to be pressed downwards in the direction of arrow 2 as shown in FIG. 10 and out of engagement with the door or window, by the action of the user's digit on the operable end 25 of the wing part 22. Once the secondary lock wing part 27 is released the wing part 22 may then be pressed towards the door or window, or frame or support 36 in the direction of arrow “2” as shown in FIG. 10 until the lock is released as shown in FIG. 11. This may conveniently be done by the user using the thumb and forefinger of a single hand.

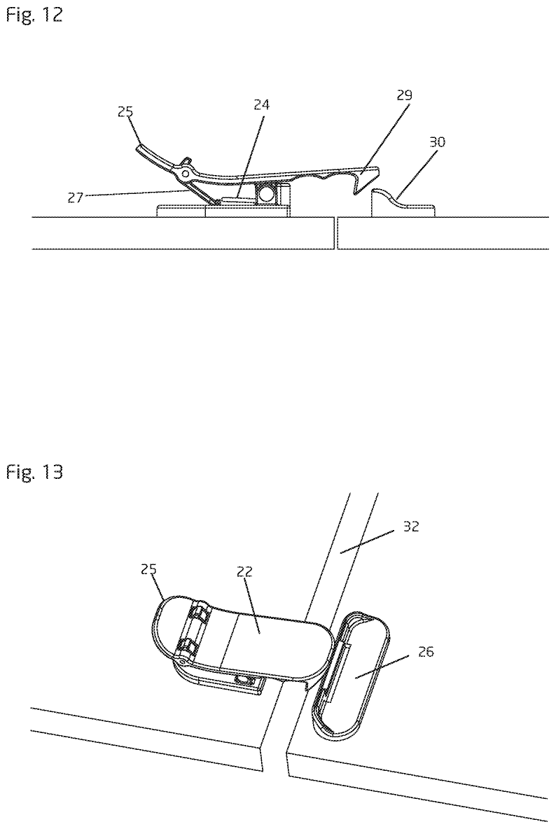

The window or door 36, 37 is then free to be moved and may be opened as shown in FIG. 12. The door or window may then be opened to the extent required and the child lock and automatically return to the blocking position when the door or window is closed and similarly the secondary lock wing part 27 automatically returns to the approximately orthogonal position in which it braces the wing part 22 against any downward movement.

This secondary required action of rotation of the secondary lock wing part 27 as well as the downward movement of the wing part 22 is significantly more difficult for a small child to achieve. As a result the child lock is more effective against being opened by a child and to such an extent that it still serves effectively as a child lock with a spring force provided by spring 24 as well as spring 28 being significantly lower than 50 Newtons. With this embodiment the child lock is still effective with a spring force on each spring 24 and 28 of about 20 Newtons. This enables the lock to be operated by adults that who have limited strength but nevertheless the required dexterity and acumen of an adult, not possessed by a child, to be able to carry out the double movement.

Thus, a child proof lock is provided which may be easily installed on the side of a frame of a sliding door or window closure member without power tools or the need to measure. The child lock effectively prevents operations by children but may be readily released by an adult.

It should be understood that although specific embodiments of the present invention have been described herein in detail, such descriptions are for purposes of illustration only and modifications may be made thereto within the scope of the invention. A number of variations of the secondary wing part of the invention may be envisaged by the skilled person which achieve the same purpose of preventing at least one of the primary wing parts from being moved to the aligned position, until being released by a separate action by the adult user. Such a secondary action is preferably required in a direction which is different and preferably orthogonal to the direction required to move the primary wing part 12, 13.

The description and drawings illustratively set forth the presently preferred invention embodiment. We intend the description and drawings to describe this embodiment and not to limit the scope of the invention. Obviously, it is possible to modify these embodiments while remaining within the scope of the following claims. Therefore, within the scope of the claims one may practice the invention otherwise than as the description and drawings specifically show and describe.

### COMPONENT LIST

1. Child lock
2. Base part
4. Wing part(s)
5. Hinge
6. Frame or support
7. Window or door
10. Child lock
11. Base part
12. Wing part
13. Wing part
14. Spring
15. Secondary lock wing part
16. Spring
20. Child lock
21. Base part
22. Wing part
24. Spring
25. Wing part end
26. Catching plate
27. Secondary lock wing part
28. Secondary lock spring
29. Hooked part
30. Recess
32. Door or window
36. Door or window
37. Support or frame

1. A child lock for a sliding window or door arranged in a frame or support, comprising a base part and a wing part pivotally arranged on a side of the base part; the base part including a means of attachment to the existing frame or support by means of adhesive or screws or like, and a spring is provided acting on the wing part and which urges the wing part into a first position out of alignment with the base part and in which first position it impedes the movement of a window or door when the lock is fitted by a user into a location adjacent to the edge of the window or door which is desired to be locked, and which wing part is movable by the user in a first direction against the action of the spring to a second position in which is does not impede the movement of the window or door and the door or window may then be opened and whilst open retains the wing part in the second position,
wherein a secondary lock wing part is provided and arranged on the wing part the secondary lock wing part being urged by means of a secondary lock spring which urges the secondary lock wing part into a locked position which acts to prevent movement of the wing part the secondary lock wing part being movable by the user in a second direction to an unlocked position in which movement of the winged part is permitted enabling the wing part to be pressed to the second position in which the movement of the window or door, is not impeded.

2. A child lock according to claim 1, wherein the secondary lock wing part is pivotally arranged on the wing part.

3. A child lock according to claim 1, wherein the second direction is approximately orthogonal to the first direction.

4. A child lock according to claim 1, wherein in the locked position the secondary wing part is braced against the frame of the sliding window or door.

5. A child lock according to claim 1, wherein a second wing part is provided, attached to the base part along an opposite edge thereof to the first wing part.

6. A child lock according to claim 5, wherein a second secondary lock is attached to the second wing part.

7. A child lock according to claim 5, wherein the secondary lock wing part 15 is pivotally attached to the wing part approximately halfway along its length.

8. A child lock according to claim 1, wherein in the locked position, the wing part extends against an edge of the door or window, and in the second position is moved out of engagement with the edge of the door or window.

9. A child lock according to claim 2, wherein the secondary lock wing part is pivotally attached to the wing part at a remote end thereof.

10. A child lock according to claim 2, wherein the locked position the secondary lock wing is arranged generally orthogonally with respect to the wing part.

11. A child lock according to claim 1, wherein a catching plate is provided and secured on an opposite surface of a door or window to that which the to the base plate is attached, such that in the locked position a hook means of the wing part engages with a corresponding recess means on the catching plate.

12. A child lock according to claim 1, wherein, in the second position, the unlocked lock wing is arranged generally adjacent to the wing part

13. A child lock according to claim 1, wherein the secondary lock wing includes a protruding tongue for engagement by the user.
